(19) United States
(12) Patent Application Publication
(10) Pub. No.: US 2012/0125126 A1
(43) Pub. Date: May 24, 2012

(54) FLUIDICS WITH THERMAL COMPENSATION FOR A FLOW-TYPE PARTICLE ANALYZER

(75) Inventor: Amirthaganesh Subramanian, San Jose, CA (US)

(73) Assignee: BECTON, DICKINSON AND COMPANY, Franklin Lakes, NJ (US)

(21) Appl. No.: 13/238,401

(22) Filed: Sep. 21, 2011

Related U.S. Application Data
(60) Provisional application No. 61/415,634, filed on Nov. 19, 2010.

(51) Int. Cl. G01N 15/00; G01N 1/00

(52) U.S. Cl. 73/863.01

(57) ABSTRACT

The present invention provides an improved fluidic system for a flow-type particle analyzer, such as a flow cytometer or hematology analyzer, that enables adjustment of the system to compensate for changes in fluid viscosity resulting from changes in temperature.

### BACKGROUND OF THE INVENTION

1. Field of the Invention

The present invention relates to instruments for the analysis of particles in a fluid, and their use.

2. Description of Related Art

Flow-type particle analyzers, such as flow cytometers, are well known analytical tools that enable the characterization of particles on the basis of optical parameters such as light scatter and fluorescence, or by electrical properties, such a impedance. In a flow cytometer, for example, particles, such as molecules, analyte-bound beads, or individual cells, in a fluid suspension are passed by a detection region in which the particles are exposed to an excitation light, typically from one or more lasers, and the light scattering and fluorescence properties of the particles are measured. Particles or components thereof typically are labeled with fluorescent dyes to facilitate detection, and a multiplicity of different particles or components may be simultaneously detected by using spectrally distinct fluorescent dyes to label the different particles or components. Typically, detection is carried out using a multiplicity of photodetectors, one for each distinct dye to be detected. Both flow and scanning cytometers are commercially available from, for example, BD Biosciences (San Jose, Calif.). A description of flow cytometers is provided in Shapiro, 2003, Practical Flow Cytometry, 4th ed. (John Wiley and Sons, Inc. Hoboken, N.J.), and in the references cited therein, all incorporated herein by reference.

In a typical flow cytometer, the particle-containing sample fluid is surrounded by a particle-free sheath fluid that forms an annular flow coaxial with the sample fluid as is passes through the detection region, thereby creating a hydrodynamically focused flow of particle-containing sample fluid in the center of the fluid stream, surrounded by particle-free sheath fluid. Typically, the ratio of sheath fluid to sample fluid is high, with the sample fluid forming only a small fraction of the total fluid flow through the detection region. Typically flow cytometer systems have been implemented as pressure fluidics in which the sample and sheath fluid are provided to a flow cell, which contains the detection region, under a pressure greater than ambient pressure. Changes in the flow rate of a pressure-driven fluidic system is achieved by varying the pressure in the sample tube and/or the sheath fluid reservoir that feed into the flow cell. Alternatively, flow cytometer systems have been implemented using vacuum fluidics in which a vacuum pump draws a vacuum downstream of the flow cell, and the sample and sheath fluids are held at ambient pressure.

U.S. Pat. No. 5,040,890, incorporated herein by reference, describes a pressure control system for use in a pressure-driven flow cytometer. The system includes a pump that pressurizes both the sample tube and the sheath reservoir, which pushes the sample fluid from the sample tube and sheath fluid from sheath reservoir through a flow cell wherein cell analysis occurs, and discharges the flow cell effluent to an open waste reservoir. A pressure regulator controls the relative pressure of the sample tube and sheath reservoir, enabling control over the relative flow rates of the sample and sheath fluids.

U.S. Pat. No. 5,395,588, incorporated herein by reference, describes a vacuum control system for use in a flow cytometer. The system includes a vacuum pump that pulls a sheath fluid from an open supply reservoir through a flow cell wherein cell analysis occurs, and discharges the flow cell effluent to an open waste reservoir. A pressure drop is created through the conduit leading from the supply reservoir to the flow cell, which also aspirates a sample consisting of a particle (e.g., cell) suspension from an open sample vessel into and through the flow cell. The flow rate of the system is regulated by monitoring the vacuum level at the outlet of the flow cell. A control circuit coupled to the vacuum sensor adjusts the electric power applied to the vacuum pump motor to maintain a predetermined vacuum level at the outlet of the flow cell.

### BRIEF SUMMARY OF THE INVENTION

The present invention provides an improved fluidic system for a flow-type particle analyzer, such as a flow cytometer or hematology analyzer, that enables adjustment of the system to compensate for changes in fluid viscosity resulting from changes in temperature. The ability to adjust the system facilitates the use of the analyzer in extreme environments, such as regions of the world that experience significant fluctuations in temperature, without the need to maintain the instrument in a temperature-controlled laboratory.

The fluidic systems of the present invention cause a hydrodynamically focused flow of sample fluid containing the particles to be analyzed to pass through flow cell, wherein analysis of the particles is carried out, by creating a pressure differential across the flow cell. The pressure differential can be either an increase in the pressure of the fluids upstream of the flow cell, in which case the fluidic system is referred to as pressure-driven, or by a decrease in pressure downstream of the flow cell, in which case the fluidic system is referred to as vacuum-driven. A pressure source, typically a pump, creates the appropriate pressure differential under the control of a feedback circuit that modulates the pump in response to a measured pressure level and a stored target desired pressure level in order to maintain the system pressure at the desired pressure level. The fluidic systems further include a temperature sensor, such as a thermistor, that measures the temperature of the fluid, and further modulates the pump in order to compensate for changes in fluid viscosity due to changes in temperature. Typically, the adjustment is achieved by modifying the target desired pressure level in response to changes in temperature; the feedback circuit then automatically maintains the system pressure at the modified desired pressure level.

In one aspect, the present invention provides an improved vacuum-driven fluidic system for a flow-type particle analyzer, such as in a flow cytometer or hematology analyzer. The vacuum-driven fluidic system includes a vacuum pump that develops a vacuum that draws sheath fluid from a sheath reservoir and sample fluid containing the particles to be analyzed from a sample tube through a flow cell, wherein analysis of the particles is carried out. Waste effluent, which is the mixture of sample and sheath fluids exiting the flow cell, is drawn through the pump and discharged into a waste reservoir. A pressure sensor (pressure transducer) is configured to measure the vacuum drawn by the vacuum pump relative to the ambient pressure, referred to herein as the static pressure drop. A control feedback circuit, referred to herein as the static control feedback circuit, is provided that enables regulating the static pressure drop by modulating the vacuum pump, such as by controlling the electric power applied to the vacuum pump motor, in response to the measured static pressure drop. The vacuum-driven fluidic system of the present invention further comprises a temperature sensor, such as a thermistor, that measures the temperature of the sample and/or sheath fluid. The temperature of the fluid is used to adjust the static pressure drop by further modulating the vacuum pump motor in order to compensate for changes in fluid viscosity due to changes in temperature.

In another aspect, the present invention provides an improved pressure-driven fluidic system for a flow-type particle analyzer, such as in a flow cytometer or hematology analyzer. The pressure-driven fluidic system includes a pressure source that pressurizes the sample and sheath fluid, which pushes sheath fluid from a sheath reservoir and sample fluid containing the particles to be analyzed from a sample tube through a flow cell, wherein analysis of the particles is carried out. Waste effluent, which is the mixture of sample and sheath fluids exiting the flow cell, is into a waste reservoir. A pressure sensor (pressure transducer) is configured to measure the pressure produced by the pump relative to the ambient pressure, referred to herein as the static pressure. A control feedback circuit, referred to herein as the static control feedback circuit, is provided that enables regulating the static pressure by modulating the vacuum pump, such as by controlling the electric power applied to the pump motor, in response to the measured static pressure. The pressure-driven fluidic system of the present invention further comprises a temperature sensor, such as a thermistor, that measures the temperature of the sample and/or sheath fluid. The temperature of the fluid is used to adjust the static pressure by further modulating the pump in order to compensate for changes in fluid viscosity due to changes in temperature.

The system pressure is held constant at the desired pressure level by the feedback control loop by modulating the pump. The modulation of the pump can conveniently be achieved by modulating the electrical power provided to the pump motor. Alternatively, the pressure provided by the pump can be modulated using one or more valves or other fluidic resistors that restrict the flow of fluid or gas from the pump.

### BRIEF DESCRIPTION OF THE SEVERAL VIEWS OF THE DRAWINGS

FIG. 1 provides a schematic representation of elements of a flow cell from a typical flow cytometer. The direction of fluid flow in FIG. 1 is from the top of the page towards the bottom.

FIG. 2 provides a schematic representation of a vacuum-driven fluidic system of the present invention. The direction of fluid flow in FIG. 2 is from the bottom of the page towards the top, and flow cell 100 is shown in an orientation that is inverted relative its orientation in FIG. 1.

FIG. 3 provides a schematic representation of a pressure-driven fluidic system of the present invention. The direction of fluid flow in FIG. 2 is from the bottom of the page towards the top, and flow cell 100 is shown in an orientation that is inverted relative its orientation in FIG. 1.

### DETAILED DESCRIPTION OF THE INVENTION

The following definitions are provided for clarity. Unless otherwise indicated, all terms are used as is common in the art. All reference cited herein, both supra and infra, are incorporated herein by reference.

A “flow-type particle analyzer” is used herein to refers to any instrument that analyzes particles suspended in a flowing fluid stream by passing the particles past one or more optical detectors, and includes, for example, analyzing or sorting flow cytometers, hematology analyzers, and cell counters. A flow-type particle analyzer contains at least two fluid sources, and the two fluid are combined by the system just prior to analysis. For example, a flow cytometer of the present invention analyzes particles suspended in a sample fluid that is hydrodynamically focused by a sheath fluid.

As used herein, “system” and “instrument” are intended to encompass both the hardware (e.g., mechanical and electronic) and associated software (e.g., computer programs) components.

Sheath fluid refers to a substantially particle-free fluid that is used to surround the particle-containing sample fluid to achieve hydrodynamic focusing, as commonly practiced in a flow cytometer.

The terms “pressure sensor”, “pressure transducer”, “vacuum sensor”, “vacuum transducer”, and “transducer”, with reference to measuring pressure, are all used interchangeably herein.

A fluidic “line”, as used herein, refers to a fluid conduit or channel for transporting fluid. Typically, the sample fluid line and sheath fluid line will consist primarily of lengths of tubing, although the lines may include valves and additional fluidic resistors.

As used herein, a “representation of a functional relationship” refers to any representation that allows determining the value of an output variable for a given value of an input variable over the range of values of interest. The term is intended to encompass representations of approximations of a true functional relationship, such as obtained by fitting a line or polynomial to empirical data, or by using a lookup table to store an output for each categorized input value, wherein the input values are categorized into a finite number of bins.

### Pressure Transducers

A typical pressure sensor incorporates a diaphragm of a piezoresistive material which generates a proportional voltage when deflected in response to a pressure or vacuum level. Suitable pressure sensors are known in the art and are commercially available from, for example, Honeywell Corporation (Morristown, N.J.). Examples include the Honeywell 26PC and 140PC series differential vacuum sensors and Sensym SDX pressure sensors.

### Temperature Sensor

Temperature sensors suitable for measuring fluid temperatures over the instrument operating temperature range, which typically will be approximately 0-45° C., more typically less, are known in the art and include, for example, thermistors, thermocouples, and resistance thermometers, also called resistance temperature detectors or resistive thermal devices (RTDs). Preferably, the temperature sensor is a thermistor of the negative temperature coefficient (NTC) type. NTC thermistors are commercially available from a number of manufacturers including, for example, Betatherm Corporation (Shrewsbury, Mass.), Keystone Thermometrics Corporation (St. Marys, Pa.), and GE Sensing (Billerica, Mass.).

### Description Based on the Figures

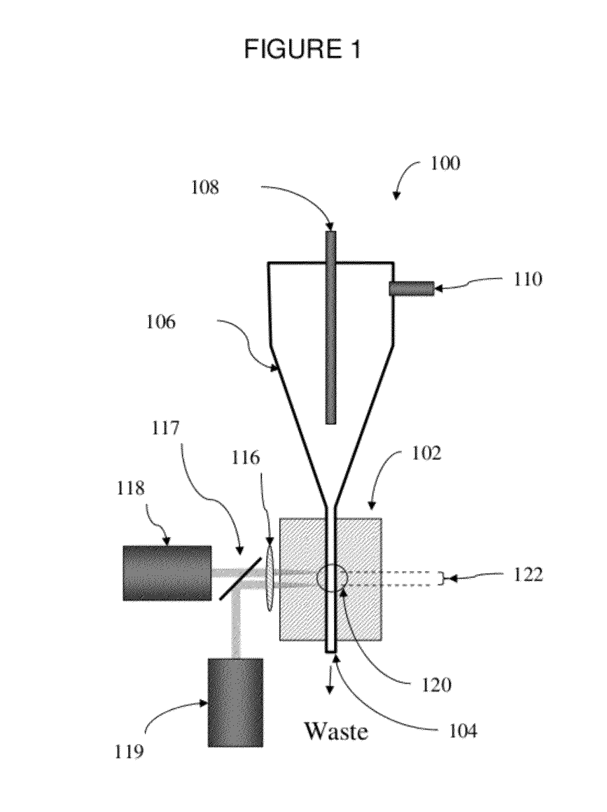

### FIG. 1

FIG. 1 depicts a schematic representation of elements of a typical flow cytometer useful with the fluidic system of the present invention. Flow cell 100 includes flow cell chamber 106, sample inlet port 108, and a sheath inlet port 110. The sample inlet port 108 and sheath inlet port 110 are adapted to provide particle-containing fluid sample and particle-free sheath fluid, respectively, into the flow cell chamber 106. Flow cell chamber 106 converges to an opening that is joined to cuvette channel 104, which passes through cuvette 102.

In use, sample fluid containing the particles to be analyzed is introduced into the flow cell 100 through sample inlet port 108, and particle-free sheath fluid is introduced into the flow cell through sheath inlet port 110. Fluids exit through cuvette channel 104 and are directed to a waste receptacle (not shown). The flow cell is designed such that the sheath fluid forms an annular flow coaxial with the sample fluid, thereby creating a hydrodynamically focused flow of particle-containing sample fluid in the center of the fluid stream, surrounded by particle-free sheath fluid. The combined fluid stream consisting of sheath fluid and sample fluid is referred to herein as the “sample stream”, “flow stream” or “particle stream”.

Optical analysis of the particles within the sample stream is carried out by exposing the sample stream in detection region 120 to excitation light from one or more excitation light sources and detecting light emanating from the detection region 120 using one or more photodetectors (not shown). Cuvette 102 is constructed, at least in part, from an optically clear material to enable optical excitation and detection. FIG. 1 depicts the use of two excitation light sources. Excitation light source 118 emits a first beam of light that is focused by lens 116 onto the sample stream at a first interrogation point within detection region 120. Excitation light source 119 emits a second beam of light that is focused by lens 116 onto the sample stream at a second interrogation point within detection region 120, wherein the second interrogation point is downstream of the first interrogation point by a distance 122. A mirror or beam-splitter 117 is used to redirect the second beam to be essentially parallel the first beam at the interrogation points.

Typically, for each of the multiple excitation light sources, multiple detectors (not shown) are present to detect fluorescent light emitted from particles in the sample stream, each detector configured to detect emitted light within a defined range of wavelengths. In addition, additional detectors are positioned to detect excitation light from at least one excitation light source that is scattered by particles at a low angle relative to the excitation beam, referred to as forward scatter light, and excitation light that is scattered by particles at nearly right angles to the excitation beam, referred to as side scatter light. Suitable photodetectors for use in a flow-type particle analyzer include, for example, photomultiplier tubes (PMTs), avalanche photo diodes, photodiodes, or any other suitable light-detecting device.

The spatial separation of the interrogation points allows for the particles to be exposed to each of the excitation lights, which are of distinct wavelengths, separately. As the particles move through the cuvette channel 104, they are first exposed to the excitation light from excitation light source 118 at the first interrogation point. The particles then move out of the first interrogation point and into the second interrogation point where they are exposed to the excitation light from excitation light source 119. The time it takes for a particle to move from the first interrogation point to the second interrogation point is referred to herein as the “laser delay”.

The laser delay is an important parameter that is used to electronically match up signals obtained from the emissions of a particle exposed to the first excitation late with signals from the emissions of the same particle exposed to the second excitation light, so that the signals are all identified as originating from the same particle. The laser delay, for a given distance 122 between interrogation points, depends entirely on the flow rate through the cuvette channel 104. For at least this reason, the flow rate through the flow cell should be maintained constant during the analysis of sample particles.

The flow rate through the flow cell can be measured by analyzing a sample of test particles that are detectable at each interrogation point. For each particle, the time between the signals obtained from the emissions of the particle exposed to the first excitation late and the signals from the emissions of the particle exposed to the second excitation light is measured. As the distance 122 between interrogation points is known from the design of the instrument, the time delay between the first and second signals enables calculation of the flow rate through the detection region 120. Alternatively, the flow rate can be measured by measuring the accumulation of fluid downstream of the flow cell over a specified period of time.

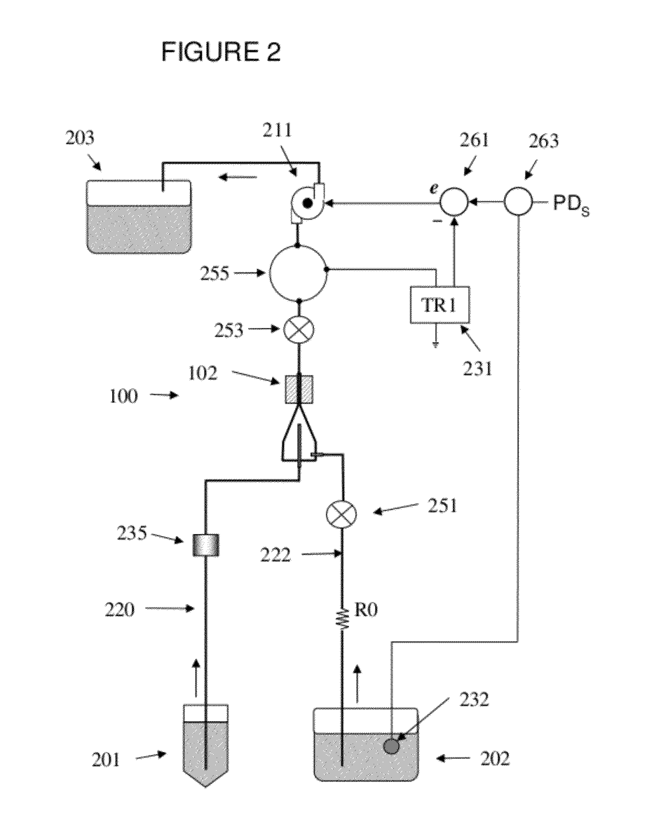

### FIG. 2

FIG. 2 depicts a schematic representation of elements of a vacuum-driven fluidic system of the present invention. A system vacuum is developed by a vacuum pump 211, which draws sheath fluid from the sheath reservoir 202 and sample fluid containing the particles to be analyzed from the sample tube 201 through flow cell 100, wherein optical analysis is carried out (optics not shown). Waste effluent, which is the mixture of sample and sheath fluids exiting the flow cell, is discharged into waste reservoir 203.

Pulsations in the vacuum developed by vacuum pump 211, which typically is a diaphragm-type pump, are attenuated by accumulator 255, also referred to as a pulsation damper. The accumulator can be a sealed canister with an internal volume many times (e.g., 10 to 1000 times) the stroke volume of the vacuum pump.

Transducer 231 measures the pressure drop developed by vacuum pump 211 relative to atmospheric pressure. This pressure drop is referred to herein as the “static pressure drop”. The static pressure drop preferably is measured from the interior of accumulator 255 so that a stable measurement is obtained.

Transducer 231 typically is connected to accumulator 255 by a short tube, such that the pressure in the tube equals the pressure in the accumulator. It is desirable to include an air bleed (e.g., a small orifice connecting the interior of the tube to the outside air) in the tube connecting transducer 231 and accumulator 255, positioned near the transducer, to allow a small amount of air to be drawn into and through the tube, drawn by the vacuum in the accumulator. The air bleed should be small enough such that the flow of air through the tube has an insignificant effect on the measurement of the static pressure drop. The minor air flow through the tube in the direction from the orifice (near the transducer) towards the accumulator prevents any fluid or foam that may be present in the accumulator from entering the tube to the transducer, which could affect the accuracy of the measurement.

Sample fluid is drawn through sample line 220 and into flow cell 100 through sample inlet port 108 (shown in FIG. 1).

Sheath fluid is drawn through sheath fluid line 222 through sheath inlet port 110 (shown in FIG. 1). The sheath line has a fluidic resistance RO that is set during or prior to instrument calibration, described below, to obtain a desired flow rate. Typically, the resistance is varied by altering the length of sheath line 220.

A flow sensor 235 is positioned on sample line 220 to provide a direct measure of the sample fluid flow rate. Suitable high precision liquid flow sensors and liquid flow meters with measurement ranges down to nanoliters per minute are commercially available from, for example, Sensirion Inc. (Westlake Village, Calif.). Flow sensor 235 facilitates setting up the flow system. The static pressure drop is adjusted to provide the desired sample fluid flow rate, and the flow sensor provides an independent measure of the sample fluid flow rate. This sensor is optional. Alternatively, the flow rate of the sample fluid can be measured by other means, such as by analyzing a sample containing a known concentration of test particles. By measuring the rate of detection of the test particles, the flow rate in the sample line 220 can be inferred.

System valve 253 enables shutting off the fluid flow through the flow cell completely. This enables the system to be paused to allow, for example, a change to a new sample source after each sample analysis. In the present system, the flow of fluid may be paused by closing a valve situated in the fluid path between the flow cell and the pump. The static pressure drop feedback loop enables maintaining the static pressure drop at a constant level during the paused state.

Valve 251 enables shutting off the sheath fluid flow completely. Valve 251 is used to temporarily stop the sheath fluid flow and temporarily increase (“boost”) the sample fluid flow rate following connection of the sample tube 201 to the sample line 220, in order to shorten the time it takes to draw sample fluid to the flow cell 100. When the sample fluid reaches the flow cell, valve 251 is opened, the flow of sheath fluid establishes a hydrodynamically focused stream, and the sample and sheath fluid flow rates return to the desired rates for analysis. Valve 251 and system valve 253 preferably will be under automatic control in a coordinated manner, such that system valve 253 can be opened for a predetermined time prior to opening valve 251 in order to permit a vacuum to be developed in said flow cell before opening said valve 251.

Temperature sensor 232 is configured to measure the temperature of the sheath fluid in the sheath reservoir 202. Typically, the level of sheath fluid is monitored using a level sensor (not shown) that extends into sheath reservoir 202. In a preferred embodiment, temperature sensor 232 and the level sensor are mounted on a single structure extending into sheath reservoir 202.

Controller 261 modulates the power of vacuum pump 211 to provide a constant static pressure drop by comparing the static pressure drop measured by transducer 231 to a stored desired static pressure drop. The desired static pressure drop is obtained from an uncompensated desired static pressure drop, PD_{S}, adjusted to compensate for the instrument operating temperature. The uncompensated desired static pressure drop, PD_{S}, is the measured static pressure drop that corresponds to the instrument running with the desired flow rate through the flow cell while operating with a sheath fluid temperature with a normal range. This uncompensated desired static pressure drop PD_{S} is then adjusted, if needed, by controller 263 based on sheath fluid temperature measured by temperature sensor 232. This provides one mechanism for adjusting the static pressure drop based on sheath fluid temperature. It will be clear that alternative feedback circuits may be used that will provide modulation of the power of vacuum pump 211 in order to maintain a constant static pressure drop based on the a desired static pressure drop and the operating temperature. For example, the functions of controller 261 and controller 263 may be embodied in a single controller by storing the desired static pressure drop with the controller.

Preferably, automatic control of the pressure drop feedback circuits (through controller 261) and of valves 251 and 253, will be provided in a coordinated manner.

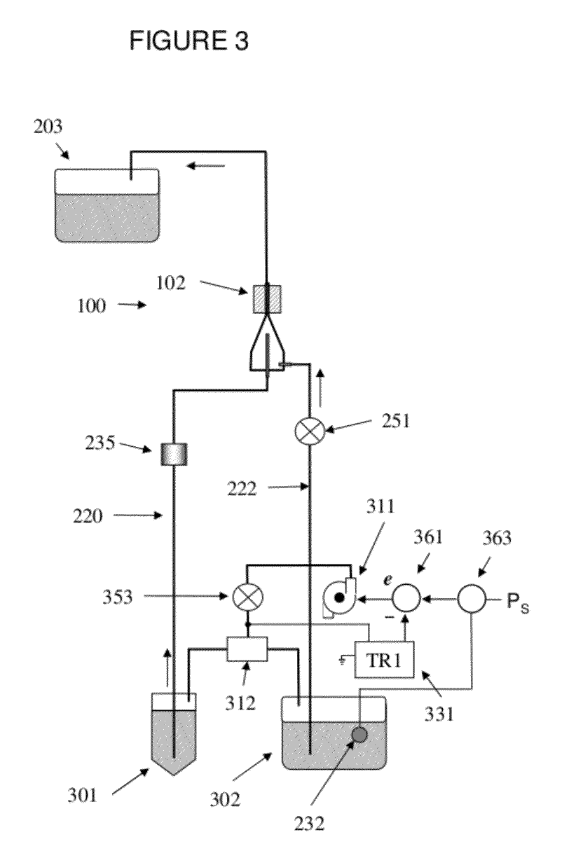

### FIG. 3

FIG. 3 depicts a schematic representation of elements of a pressure-driven fluidic system of the present invention. A system pressure is developed by a pump 311, which pressurizes sheath reservoir 302 and sample tube 301, pushing the fluids through flow cell 100, wherein optical analysis is carried out (optics not shown). Waste effluent, which is the mixture of sample and sheath fluids exiting the flow cell, is discharged into waste reservoir 203. The pressure provided by pump 311 is first passed through pressure controller 312, which controls the apportionment of the pressure between the sheath reservoir 302 and sample tube 301. Typically, the pressure provided to the sample tube is somewhat higher than that provided to the sheath reservoir.

Pressure transducer 331 measures the pressure developed by pump 311 relative to atmospheric pressure. This pressure is referred to herein as the “static pressure”.

Sample fluid is pushed through sample line 220 and into flow cell 100 through sample inlet port 108 (shown in FIG. 1).

Sheath fluid is pushed through sheath fluid line 222 through sheath inlet port 110 (shown in FIG. 1).

A flow sensor 235 is positioned on sample line 220 to provide a direct measure of the sample fluid flow rate. Flow sensor 235, which is optional, facilitates setting up the flow system, as in the vacuum-driven fluidics described above.

System valve 353 enables shutting off the fluid flow through the flow cell completely. This enables the system to be paused to allow, for example, a change to a new sample source after each sample analysis. In a pressure-driven system, the flow of fluid may be paused by closing a valve situated in the fluid path between the pump and the sheath reservoir and sample tube. The static pressure feedback loop enables maintaining the static pressure at a constant level during the paused state.

Valve 251 enables shutting off the sheath fluid flow completely. Valve 251 is used to temporarily stop the sheath fluid flow and temporarily increase (“boost”) the sample fluid flow rate following connection of the sample tube 201 to the sample line 220, in order to shorten the time it takes to push sample fluid to the flow cell 100. When the sample fluid reaches the flow cell, valve 251 is opened, the flow of sheath fluid establishes a hydrodynamically focused stream, and the sample and sheath fluid flow rates return to the desired rates for analysis. Valve 251 and system valve 353 preferably will be under automatic control in a coordinated manner, such that system valve 353 can be opened for a predetermined time prior to opening valve 251 in order to permit a pressure to be developed in said flow cell before opening said valve 251.

Controller 361 modulates the power of pump 311 to provide a constant static pressure by comparing the static pressure measured by transducer 331 to a stored desired static pressure. The desired static pressure is obtained from an uncompensated desired static pressure, P_{S}, adjusted to compensate for the instrument operating temperature. The uncompensated desired static pressure, P_{S}, is the measured static pressure that corresponds to the instrument running with the desired flow rate through the flow cell while operating with a sheath fluid temperature with a normal range. This uncompensated desired static pressure P_{S} is then adjusted, if needed, by controller 363 based on sheath fluid temperature measured by temperature sensor 232. This provides one mechanism for adjusting the static pressure based on sheath fluid temperature. It will be clear that alternative feedback circuits may be used that will provide modulation of pump 311 in order to maintain a constant static pressure based on the a desired static pressure and the operating temperature. For example, the functions of controller 361 and controller 363 may be embodied in a single controller by storing the desired static pressure drop with the controller.

Preferably, automatic control of the pressure feedback circuits (through controller 361) and of valves 251 and 353, will be provided in a coordinated manner.

### System Calibration

The sample flow rate depends both on the relative resistances of the sample line and the sheath fluid line, and on the pressure differential created by the pump. The individual values of the sample line and sheath fluid line resistances and the pressure drop are not critical as long as the resulting sample flow rate is the desired flow rate. An initial system calibration of a flow-type particle analyzer is carried out to set the resistances and pressure differential to obtain the desired sample flow rate at a standard operating temperature. This initial system calibration can be carried out as it is using previously described flow cytometers. Once calibrated, the system of the present invention is then able to maintain the desired sample flow rate despite changes to the fluid temperature.

Typically, the system calibration is carried out iteratively, adjusting one parameter while holding the others constant, until desired settings are obtained. In a typical flow cytometer, the sheath fluid flow rate is significantly greater than the sample fluid flow rate. For example, a typical flow cytometer may run with a sheath fluid flow rate of about 15 ml/minute and a sample fluid flow rate about 90 μl/minute. Because of this disparity in flow rates, it is preferable to first set a desired sheath fluid flow rate and pump power level, and then adjust the sheath fluid line resistance to obtain the desired sample fluid flow rate.

The resistance of the sample fluid line typically is determined by the initial design of a particular instrument and is not subsequently varied. The exact value is not critical, as the final sample fluid flow rate is determined by adjusting the sheath fluid line resistance and the pump. A nominal length of tubing is selected for the sheath fluid line, which sets an initial resistance of the sheath fluid line. The power of the pump is adjusted to obtain a desired sheath flow rate. The pressure differential at this step can be measured and stored in the system for use by the feedback controller during instrument operation. The length of tubing of the sheath fluid line is then altered to adjust the resistance of the sheath fluid line until the desired sample fluid flow rate is obtained. This final adjustment of the resistance of the sheath fluid line may result in a minor changed in the pressure differential, but the change typically is insubstantial and the pressure differential measured just prior to this final adjustment typically can be used with the feedback controller. Alternatively, the pressure differential measured after the sample fluid flow rate is set is stored in the system for use by the feedback controller during instrument operation.

The sheath flow rate can be measured by running the system for a known amount of time an measuring the amount of fluid discharged. Alternatively, a short tube of known volume is placed in-line between the sheath fluid reservoir and the sheath fluid line. While the system is running, the tube is disconnected from the reservoir, and the time it takes for the tube to empty is measured. Using a short tube of a clear material, such as glass, facilitates this measurement, as the fluid in the tube is readily observed. The sample flow rate is measured using a flow-rate meter in-line with the sample fluid line or by measuring the volume flowing through the line in a given time, as with the sheath fluid line.

The system preferably is calibrated while being operated under a desired standard operating temperature, such as room temperature, which corresponds to the temperature under which the system will be used most frequently, or at an approximate mid-point of the temperature range under which the system will be used. This standard operating temperature is the operating temperature that does not require any adjustment of the pressure difference to compensate for temperature-induced changes of viscosity. In other words, in a vacuum-based system of FIG. 2, calibrated under the desired standard operating temperature, the static pressure drop, PD_{S}, that is stored in the system is the static pressure drop measured by transducer 231 after adjusting the power of the pump to obtain the desired flow rates. Similarly, in a pressure-based system of FIG. 3, calibrated under the desired standard operating temperature, the static pressure, P_{S}, stored in the system is the static pressure measured by transducer 331 after adjusting the power of the pump to obtain the desired flow rates.

The system also can be calibrated at a temperature higher or lower than the desired standard operating temperature. For example, in a vacuum-based system, the uncompensated desired static pressure drop, PD_{S}, is obtained by calculating the PD_{S} that would yield the measured static pressure drop after the adjustment to compensate for the difference in temperature between the calibration temperature and the standard operating temperature. The compensation is based on the predetermined relationship between temperature and the pump power required to maintain a flow rate, which is stored in the system for use by controller 263 or 263 (further described below).

### System Running State

While the system is running, the feedback circuit modulates the power of the pump to maintain the pressure differential at a stored value (PD_{S} or P_{S}) that is further modified to compensate for any change in viscosity of the sample and sheath fluids due to a change in temperature.

Modification of the stored pressure differential to compensate for changes in temperature is based on a determination of the functional relationship between the temperature and the pressure differential required to maintain a constant flow rate. In general, for a sheath fluid, which typically is mostly water, the functional relationship between temperature and the pressure differential required to maintain a constant flow rate is linear or approximately linear. Thus, the relationship is well approximated by a linear function,

PDiff=C₁·T+C₂,

wherein PDiff is the pressure differential, T is the temperature of the fluid, and C1 and C2 are constant coefficients determined by fitting the line to empirically determined data. A representation of this relationship is stored in the system, either in a firmware or software component of the system, and is used to adjust the stored pressure differential value (PD_{S} or P_{S}) that is the input to the pump controller. The stored representation of the functional relationship can be simplified by recording only the constants that define the linear function, i.e., storing only the values C₁ and C₂.

The relationship between temperature and the pressure differential required to maintain a constant flow rate preferably is determined empirically. The instrument is placed in a thermally controlled environment, or the equivalent, to control the temperature of the fluids. The system is first calibrated at the desired standard operating temperature to obtain an initial reference pressure differential (PD_{S} or P_{S}) corresponding to the desired flow rate. The temperature is varied over a range of operating temperatures and, at each variant temperature, the pressure differential required to obtain the same desired flow rate is measured.

### Pausing and Restarting the System

A vacuum-based system can be stopped (i.e., the system paused) by closing valve 253. The static pressure feedback loop maintains the static pressure drop at the constant value that existed immediately prior to pausing the flow. As the flow has stopped, this results in some reduction in the power of vacuum pump 211. To restart a vacuum-driven system, system valve 253 is opened, allowing vacuum pump 211 to draw a vacuum through the flow cell. The power to the pump is adjusted to maintain the static pressure drop at the value determined at setup to provide the desired flow rate through the flow cell.

Similarly, flow of fluid through the flow cell in a pressure-based system can be stopped (i.e., the system paused) by closing valve 353. The static pressure feedback loop maintains the static pressure at the constant value that existed immediately prior to pausing the flow. As the flow has stopped, this results in some reduction in the power of pump 311. To restart a pressure-driven system, system valve 353 is opened, allowing pump 311 to pressurize the sample tube and sheath reservoir. The power to the pump is adjusted to maintain the static pressure at the value determined at setup to provide the desired flow rate through the flow cell.

Systems will routinely be paused to allow for replacement of the sample tube. Upon restarting, sample fluid from the new sample tube will need to be drawn (or pushed) through the sample fluid line before reaching the flow cell. It is desirable to speed up (boost) this initial flow of sample until the sample fluid line is full of sample fluid from the new tube. Maximum sample fluid flow is achieved by shutting off sheath fluid flow by closing valve 251. When restarting the system, system valve 253 or 353 is opened for a predetermined time, which will be based on the flow rate and volume of the sample fluid line, prior to opening valve 251 in order to cause the flow of sample fluid through the sample line and into the flow cell prior to opening valve 251.

### Two-Temperature System

The example systems described in FIGS. 2 and 3, above, contain a temperature sensor to measure the temperature of the sheath fluid. Typically, the temperatures of the sheath fluid and sample fluid will be the same, typically at ambient temperature. However, in some applications, it may be desirable to use a sample that at a different temperature. For example, it may be desirable to run samples that have been store cold, without warming up the sample to ambient temperature before analysis.

Changes in the sample fluid temperature relative to the sheath fluid temperature result in changes in the relative resistances of the sample fluid and sheath fluid lines, which determines the relative flow of sample fluid to sheath fluid. In alternative embodiments of the present invention, two temperature sensors, one for measuring the temperature of the sample fluid and one for measuring the temperature of the sheath fluid, are use to enable compensation for independent changes in sample fluid and sheath fluid temperatures. Preferably, the sample fluid temperature sensor will be positioned outside of the sample tube to avoid contamination of the sample or by the sample.

For a vacuum-based system, such as shown in FIG. 2, a sample fluid temperature sensor is connected to controller 261 (directly, or through controller 263), which modulates the power of the pump. An appropriate compensation, based on the temperatures of the two fluids, is determined by the controller based on a calculated or empirically pre-determined change in the relative resistances of the sample fluid and sheath fluid lines. The controller 261 modulates the power of the pump to adjust the combined flow of sample and sheath flow such that the sample flow rate is maintained.

In a vacuum-based system, modulation of the system to compensate for changes in sample fluid temperature independently of the sheath fluid temperature will result in changes in the total fluid flow rate through the flow cell. This is in contrast to a system in which the sample and sheath fluids are maintained at equal temperatures (which may vary jointly), in which the feedback circuit that maintains the sample flow rate also maintains the total flow through the flow cell, as the ratio of sample to sheath fluids is constant. Typically, although maintaining a constant sample flow rate is desirable for good assay results, the constancy of the sheath fluid flow rate has little effect, if any, on assay results.

For a pressure-based system, such as shown in FIG. 3, the sample fluid temperature sensor and the sheath fluid temperature sensors are connected to a controller (either controller 361 or a separate, but coordinated controller) that is operably connected to pressure controller 312, which controls the apportionment of the pressure between the sheath reservoir 302 and sample tube 301. The controller provides coordinated control of both the power of the pump (i.e., total pressure) and the distribution of pressure. An appropriate modulation of the apportionment of the pressure between the sheath reservoir 302 and sample tube 301 is determined by the controller based on a calculated or empirically pre-determined change in the relative resistances of the sample fluid and sheath fluid lines.

In a pressure-based system, modulation of the system to compensate for changes in sample fluid temperature independently of the sheath fluid temperature need not result in changes in the total fluid flow rate through the flow cell. This is because the pressures the sample and sheath containers can be controlled independently. For example, to compensate for a refrigerated sample, the pressure to the sample tube can be increased to compensate for the increased viscosity of the sample fluid, thus maintaining the sample flow rate, without affecting the sheath fluid flow rate.

We claim:

1. A fluidic system for a flow-type particle analyzer, comprising:
a) a flow cell having
a sample inlet port,
a sheath fluid inlet port,
an outlet port, and
a cuvette, wherein said cuvette contains a cuvette channel having a input end and an output end, wherein said input end is in fluidic communication with said sample inlet port and said sheath fluid inlet port, and said output end is in fluidic communication with said outlet port;
b) a sample line in fluidic communication with said sample inlet port, for providing a particle-containing sample fluid from a sample fluid container;
c) a sheath fluid line in fluidic communication with said sheath fluid inlet port, for providing a sheath fluid from a sheath fluid reservoir;
d) an outlet line in fluidic communication with said outlet port;
e) a pump having a controllable power level, configured to create a pressure differential between said outlet port and said sheath fluid inlet and sample inlet ports, to cause a flow of said sample and sheath fluids through said flow cell;
f) a pressure sensor configured to measure said pressure differential;
g) a control feedback circuit configured to regulate the power of said pump in response to said pressure differential and a target pressure value;
h) a temperature sensor configured to measure the temperature of said sample fluid or said sheath fluid; and
i) a controller for modifying said target pressure value in response to the temperature measured by said temperature sensor.

2. A vacuum-driven fluidic system for a flow-type particle analyzer, comprising:
a) a flow cell having
a sample inlet port,
a sheath fluid inlet port,
an outlet port, and
a cuvette, wherein said cuvette contains a cuvette channel having a input end and an output end, wherein said input end is in fluidic communication with said sample inlet port and said sheath fluid inlet port, and said output end is in fluidic communication with said outlet port;
b) a sample line in fluidic communication with said sample inlet port, for providing a particle-containing sample fluid from a sample fluid container;
c) a sheath fluid line in fluidic communication with said sheath fluid inlet port, for providing a sheath fluid from a sheath fluid reservoir;
d) an outlet line in fluidic communication with said outlet port;
e) a vacuum pump having a controllable power level, in vacuum communication with said outlet line, configured to draw a vacuum in said outlet line, thereby pulling said sample and sheath fluids through said flow cell;
f) a pressure sensor configured to measure a pressure differential between said cuvette outlet port and atmospheric pressure;
g) a control feedback circuit configured to regulate the power of said vacuum pump in response to said pressure differential and a target pressure value;
h) a temperature sensor configured to measure the temperature of said sample fluid or said sheath fluid; and
i) a controller for modifying said target pressure value in response to the temperature measured by said temperature sensor.

3. A pressure-driven fluidic system for a flow-type particle analyzer, comprising:
a) a flow cell having
a sample inlet port,
a sheath fluid inlet port,
an outlet port, and
a cuvette, wherein said cuvette contains a cuvette channel having a input end and an output end, wherein said input end is in fluidic communication with said sample inlet port and said sheath fluid inlet port, and said output end is in fluidic communication with said outlet port;
b) a sample line in fluidic communication with said sample inlet port, for providing a particle-containing sample fluid from a sample fluid container;
c) a sheath fluid line in fluidic communication with said sheath fluid inlet port, for providing a sheath fluid from a sheath fluid reservoir;
d) an outlet line in fluidic communication with said outlet port;
e) a pump having a controllable power level, in communication with said sample fluid container and said sheath fluid reservoir, configured to produce and increased pressure in said sample fluid container and said sheath fluid reservoir, thereby pushing said sample and sheath fluids through said flow cell;
f) a pressure sensor configured to measure a pressure differential between said increased pressure provided by said pump and atmospheric pressure;
g) a control feedback circuit configured to regulate the power of said pump in response to said pressure differential and a target pressure value;
h) a temperature sensor configured to measure the temperature of said sample fluid or said sheath fluid; and
i) a controller for modifying said target pressure value in response to the temperature measured by said temperature sensor.

4. The fluidic system of claim 2, further comprising;
a) a first valve, positioned in line with said sheath fluid line, configured to control the flow of said sheath fluid into said flow cell;
b) a second valve, positioned in line with said outlet line, configured to control the flow of said sheath fluid out of said flow cell; and
c) a valve controller operatively connected to said first and second valves.

5. The fluidic system of claim 3, further comprising;
a) a first valve, positioned in line with said sheath fluid line, configured to control the flow of said sheath fluid into said flow cell;
b) a second valve, configured to control the pressure provided by said pump;
c) a valve controller operatively connected to said first and second valves.
